(19) United States
(12) Patent Application Publication
(10) Pub. No.: US 2012/0190537 A1
(43) Pub. Date: Jul. 26, 2012

(54) CATALYST SUPPORT FROM FLAME-SPRAY PYROLYSIS AND CATALYST FOR AUTOTHERMAL PROPANE DEHYDROGENATION

(75) Inventors: Stefan Hannemann, Mannheim (DE); Dieter Stützer, Dudenhofen (DE); Goetz-Peter Schindler, Ludwigshafen (DE); Peter Pfab, Shaker Heights, OH (US); Frank Kleine Jäger, Bad Durkheim (DE); Dirk Grossschmidt, Mannheim (DE)

(73) Assignee: BASF SE, Ludwigshafen (DE)

(21) Appl. No.: 13/356,766

(22) Filed: Jan. 24, 2012

Related U.S. Application Data
(60) Provisional application No. 61/435,802, filed on Jan. 25, 2011.

(51) Int. Cl. B01J 23/56; C01G 25/02; B01J 32/00

(52) U.S. Cl. 502/242; 502/303; 502/304; 502/439; 423/608

(57) ABSTRACT

The invention relates to a method of production of catalyst support particles, containing zirconium dioxide and optionally silicon oxide, comprising the steps
(i) preparation of a solution containing precursor compounds of zirconium dioxide and optionally of silicon dioxide,
(ii) converting the solution(s) to an aerosol,
(iii) bringing the aerosol into a directly or indirectly heated pyrolysis zone,
(iv) carrying out pyrolysis, and
(v) separation of the catalyst particles formed from the pyrolysis gas.

### CROSS-REFERENCE TO RELATED APPLICATIONS

This application claims benefit (under 35 USC 119(e)) of U.S. Provisional Application 61/435,802, filed Jan. 25, 2011, which is incorporated by reference.

### BACKGROUND OF THE INVENTION

The invention relates to oxide catalyst supports and catalyst particles produced therefrom, a method of production thereof and the use of the catalyst particles as dehydrogenation catalyst.

Production of dehydrogenation catalysts by impregnation processes or spray drying is known. In these methods the catalytically active metals are applied on an oxide support or a silicate support by impregnation processes or the catalyst is produced by spray drying of coprecipitated oxide precursors.

DE-A 196 54 391 describes the production of a dehydrogenation catalyst by impregnation of essentially monoclinic ZrO₂ with a solution of Pt(NO₃)₂ and Sn(OAc)₂ or by impregnation of ZrO₂ with a first solution of Pt(NO₃)₂ and then a second solution of La(NO₃)₃. The impregnated supports are dried and then calcined. The catalysts thus obtained are used as dehydrogenation catalysts, e.g. for the dehydrogenation of propane to propene.

The catalyst support is produced in the usual way by the sol-gel process, precipitation of the salts, dehydration of the corresponding acids, dry mixing, slurrying or spray drying. For example, for production of a ZrO₂.Al₂O₃.SiO₂ mixed oxide, first a zirconium oxide with high water content, of general formula ZrO.×H₂O, can be produced by precipitation of a suitable zirconium-containing precursor. Suitable precursors of zirconium are for example Zr(NO₃)₄, ZrOCl₂, or ZrCl₄. The actual precipitation is effected by adding a base such as NaOH, KOH, Na₂CO₃ and NH₃ and is described for example in EP-A 0 849 224.

For production of a ZrO₂.SiO₂ mixed oxide, the zirconium-containing precursor can be mixed with a silicon-containing precursor. Very suitable precursors for SiO₂ are for example water-containing sols of SiO₂ such as Ludox™. The two components can be mixed for example by simple mechanical mixing or by spray drying in a spray tower.

A known method of production of metal catalysts by flame-spray pyrolysis is described in Pisduangnawakij et al., Applied Catalysis A: General 370 1-6, 2009. In this, a solution containing precursor compounds of platinum and tin and of aluminum oxide as support in xylene is converted to an aerosol, this is treated in an inert carrier gas in a pyrolysis reactor at a temperature above the decomposition temperature of the precursor compounds and then the finely-divided metal that has formed is separated from the carrier gas.

### A SUMMARY OF THE INVENTION

The problem to be solved by the present invention is to provide an inexpensive and time-saving method of production of oxide supports for dehydrogenation catalysts, wherein the dehydrogenation catalysts obtained should be comparable in activity and selectivity to the catalysts of the prior art, produced exclusively by impregnation processes or spray drying.

This problem is solved by a method of production of catalyst support particles, containing zirconium dioxide and optionally silicon oxide, comprising the steps
(i) preparation of a solution containing precursor compounds of zirconium dioxide and optionally of silicon oxide,
(ii) converting the solution(s) to an aerosol,
(iii) bringing the aerosol into a directly or indirectly heated pyrolysis zone,
(iv) carrying out pyrolysis, and
(v) separation of the catalyst particles formed from the pyrolysis gas.

### A BRIEF DESCRIPTION OF THE FIGURE

FIG. 1 illustrates, for comparison, the activities and selectivities of the reference catalyst (−) with support prepared by precipitation and spray drying and of the catalyst according to the invention, whose support is derived from flame synthesis (▪), with the additional elements applied in each case by impregnation.

### A DETAILED DESCRIPTION OF THE INVENTION

The oxide-forming precursor compounds are fed as aerosol to the pyrolysis zone. It is preferable if the aerosol fed to the pyrolysis zone is obtained by nebulization of just one solution, which contains all the oxide-forming precursor compounds. In this way it is always ensured that the composition of the particles produced is homogeneous and constant. During preparation of the solution that is to be converted to an aerosol, the individual components are thus preferably selected so that the oxide-forming precursors contained in the solution are dissolved uniformly alongside one another until nebulization of the solution. Alternatively it is also possible to use several different solutions, which together contain the oxide-forming precursors. The solution or solutions can contain both polar and apolar solvents or solvent mixtures.

In the pyrolysis zone, decomposition and/or oxidation of the oxide precursors take place, with formation of the oxide. Pyrolysis generally results in spherical particles with varying specific surface.

The temperature in the pyrolysis zone is at sufficient temperature for oxide formation, usually between 500 and 2000° C. Pyrolysis is preferably carried out at a temperature from 900 to 1500° C.

The pyrolysis reactor can be heated indirectly from outside, for example by means of an electric furnace. Owing to the temperature gradient from outside to inside that is required in indirect heating, the furnace must be much hotter than corresponds to the temperature required for pyrolysis. Indirect heating requires a thermally stable furnace material and an expensive reactor construction, but the total amount of gas required is less than in the case of a flame reactor.

In a preferred embodiment the pyrolysis zone is heated by a flame (flame-spray pyrolysis). The pyrolysis zone then comprises an ignition device. For direct heating, usual combustible gases are used, although preferably hydrogen, methane or ethylene is used. The temperature in the pyrolysis zone can be adjusted as required by means of the ratio of the amount of combustible gas to the total amount of gas. To keep the total amount of gas low but nevertheless achieve a temperature as high as possible, the pyrolysis zone can also be supplied with pure oxygen instead of air as the O₂ source for combustion of the combustible gases. The total amount of gas also comprises the carrier gas for the aerosol and the evaporated solvent of the aerosol. The aerosol or aerosols supplied to the pyrolysis zone are preferably fed directly into the flame. Although air is generally preferred as carrier gas for the aerosol, it is also possible to use nitrogen, CO₂, O₂ or a combustible gas, for example hydrogen, methane, ethylene, propane or butane.

In another embodiment of the method according to the invention, the pyrolysis zone is heated by an electric plasma or an inductive plasma.

A flame-spray pyrolysis device generally comprises a storage container for the liquid to be nebulized, feed pipes for carrier gas, combustible gas and oxygen-containing gas, a central aerosol nozzle, and an annular burner arranged around this, a device for gas-solid separation comprising a filter element and a discharging device for the solid and an outlet for the exhaust gas. The particles are cooled by means of a quench gas, e.g. nitrogen or air.

To produce a balanced temperature profile, the combustion space, which is preferably tube-shaped, is heat-insulated.

As the pyrolysis result, a pyrolysis gas is obtained, which contains spherical particles with varying specific surface. The size distribution of the particles obtained results from, among other things, the droplet size spectrum of the aerosol fed into the pyrolysis zone and the concentration of the solution or solutions used.

Preferably, prior to separation of the particles formed from the pyrolysis gas, the pyrolysis gas is cooled so that sintering of the particles is excluded. For this reason the pyrolysis zone preferably comprises a cooling zone, which adjoins the combustion space of the pyrolysis reactor. Cooling of the pyrolysis gas and of the catalyst particles contained therein to a temperature of about 100-500° C. is generally required, depending on the filter element used. Cooling to approx. 100-150° C. preferably takes place. After leaving the pyrolysis zone, the pyrolysis gas, containing catalyst particles, and partially cooled, enters a device for separating the particles from the pyrolysis gas, which comprises a filter element. For cooling, a quench gas, for example nitrogen, air or water-moistened gas, is fed in.

Suitable zirconium dioxide-forming precursor compounds are alcoholates, such as zirconium(IV) ethanolate, zirconium(IV) n-propanolate, zirconium(IV) isopropanolate, zirconium(IV) n-butanolate and zirconium(IV) tert-butanolate. In a preferred embodiment of the method according to the invention, zirconium(IV) propanolate, preferably as solution in n-propanol, is used as ZrO₂ precursor compound.

Other suitable zirconium dioxide-forming precursor compounds are carboxylates, such as zirconium acetate, zirconium propionate, zirconium oxalate, zirconium octoate, zirconium 2-ethyl-hexanoate, zirconium neodecanoate, zirconium acetate, zirconium propionate, zirconium oxalate, zirconium octanoate, zirconium 2-ethylhexanoate, zirconium neodecanoate and/or zirconium stearate, zirconium propionate. In another preferred embodiment of the method according to the invention, zirconium(IV) acetylacetonate is used as precursor compound.

In one embodiment, the precursor compounds additionally comprise a silicon dioxide precursor compound. Possible precursors for silicon dioxide are organosilanes and reaction products of SiCl₄ with lower alcohols or lower carboxylic acids. It is also possible to use condensates of the aforementioned organosilanes and/or -silanols with Si—O—Si units. Siloxanes are preferably used. It is also possible to use SiO₂. In a preferred embodiment of the method according to the invention, the precursor compounds comprise hexamethyldisiloxane as silica-forming precursor compound.

Both polar and apolar solvents or solvent mixtures can be used for production of the solution or solutions required for aerosol formation.

Preferred polar solvents are water, methanol, ethanol, n-propanol, iso-propanol, n-butanol, tert-butanol, n-propanone, n-butanone, diethyl ether, tert-butyl-methyl ether, tetrahydrofuran, C₁-C₈ carboxylic acids, ethyl acetate and mixtures thereof.

In a preferred embodiment of the method according to the invention, one or more of the precursor compounds, preferably all the precursor compounds are dissolved in a mixture of acetic acid, ethanol and water. Preferably this mixture contains 30 to 75 wt. % acetic acid, 30 to 75 wt. % ethanol and 0 to 20 wt. % water. In particular, zirconium(IV) acetylacetonate and hexamethyldisiloxane are dissolved in a mixture of acetic acid, ethanol and water.

Preferred apolar solvents are toluene, xylene, n-heptane, n-pentane, octane, isooctane, cyclohexane, methyl, ethyl or butyl acetate or mixtures thereof. Hydrocarbons or mixtures of hydrocarbons with 5 to 15 carbon atoms are also suitable. Xylene is especially preferable.

In particular, Zr(IV) ethylhexanoate and hexamethyldisiloxane are dissolved in xylene.

The catalyst support particles obtained by spray pyrolysis preferably have a specific surface of 36 to 70 m²/g.

The catalyst support particles obtained are then impregnated with one or more solutions containing compounds of platinum, tin and at least one other element, selected from lanthanum and cesium. The impregnated catalyst support particles are dried and calcined.

The invention therefore also relates to a method of production of catalyst particles comprising platinum and tin and at least one other element, selected from lanthanum and cesium, on a zirconium dioxide-containing support, wherein the method comprises steps (i) to (v) and additionally steps
(vi) impregnation of the catalyst support particles formed with one or more solutions containing compounds of platinum, tin and of at least one other element, selected from lanthanum and cesium,
(vii) drying and calcining of the impregnated catalyst support particles.

As a rule the precursor compounds used are compounds that can be converted by calcination to the corresponding oxides. For example, hydroxides, carbonates, oxalates, acetates, chlorides or mixed hydroxycarbonates of the corresponding metals are suitable.

As a rule the dehydrogenation-active component is applied by impregnation. Instead of by impregnation, however, the dehydrogenation-active component can also be applied by other methods, for example spraying of the metal salt precursor. Platinum is preferably used as H₂PtCl₆ or Pt(NO₃)₂. Both water and organic solvents are suitable as solvent. Water and lower alcohols such as methanol and ethanol are especially suitable.

Suitable precursors when using precious metals as dehydrogenation-active component are also the corresponding precious metal sols, which can be produced by one of the known methods, for example by reduction of a metal salt in the presence of a stabilizer such as PVP with a reducing agent. There is a detailed account of the production technology in German patent application DE 195 00 366.

The content of platinum as dehydrogenation-active component in the catalysts is 0.01 to 5 wt. %, preferably 0.05 to 1 wt. %, especially preferably 0.05 to 0.5 wt. %.

In addition, the catalyst contains at least tin in amounts from 0.01 to 10 wt. %, preferably 0.05 to 2 wt. %. Suitable tin compounds are carboxylates such as tin(II) acetate, tin 2-ethylhexanoate or tin(II) chloride.

In a preferred embodiment the loading with Pt is 0.05 to 1 wt. % and the loading with Sn is 0.05 to 2 wt. %.

Furthermore, the active mass can contain the following additional components, with at least cesium or lanthanum being contained:
cesium and optionally potassium with a content between 0.1 and 10 wt. %. Compounds that can be converted to the oxides by calcination, for example hydroxides, carbonates, oxalates, acetates or formates, are used as cesium or potassium oxide precursors.
lanthanum and optionally cerium with a content between 0.1 and 10 wt. %. If lanthanum is used, for example lanthanum oxide carbonate, La(OH)₃, La₂(CO₃)₃, La(NO₃)₃, lanthanum formate, lanthanum acetate and lanthanum oxalate are suitable as precursor salts.

After applying the active components on the catalyst support, calcination is carried out at temperatures from 400 to 1000° C., preferably from 500 to 700° C., especially preferably at 550 to 650° C.

The present invention also relates to the supports and catalyst particles obtainable by the method according to the invention. These preferably have a specific surface of 20 to 70 m²/g.

In a preferred embodiment the catalyst supports have the following percentage composition: 30 to 99.5 wt. % ZrO₂, 0.5 to 25 wt. % SiO₂. The catalyst particles additionally contain 0.1 to 1 wt. % Pt, 0.1 to 10 wt. % Sn, La and/or Cs, relative to the mass of the support, wherein at least Sn and at least La or Cs are contained.

The present invention also relates to the use of the catalyst particles as hydrogenation catalysts or dehydrogenation catalysts. Alkanes, such as butane and propane, but also ethylbenzene, are preferably dehydrogenated.

The use of the catalysts according to the invention for the dehydrogenation of propane to propene is especially preferred.

The invention is explained in more detail with the following example.

### Example

### Chemicals Used

Zirconium acetylacetonate Zr(acac)₂ (98%)

Zirconium(IV) propoxide Zr(OPr)₄ (70% in 1-propanol)

Hexamethyldisiloxane (HMDSO) (98%)

CsNO₃

KNO₃

SnCl₂.2H₂O

La(NO₃)₃.6H₂O

Mixture of acetic acid (100%), ethanol (96%) and water (deionized)

Xylene (mixture of isomers)

### Preparation of the Solutions of the Precursor Compounds

The solvent is HoAc:EtOH:H₂O in the proportions by weight 4.6 to 4.6 to 1. The acetic acid-ethanol mixture is freshly prepared. The precursor compounds for Si and Zr are dissolved therein.

The composition of the polar solutions of the precursor compounds for the examples is shown in Table 1.

TABLE 1
Compositions of the solutions of the precursor
compounds for apolar mixture (xylene)

| [g] | Substance | Purity [wt. %] |
|---|---|---|
| 374.40 | Zr(IV) ethylhexanoate | 97 |
| 10.11 | Hexamethyldisiloxane | 99 |

### Production of the Catalyst Support Particles by Flame-Spray Pyrolysis

The solution containing the precursor compounds was supplied by means of a piston pump via a two-component nozzle and atomized with a corresponding amount of air. To reach the corresponding temperatures, sometimes a support flame from an ethylene-air mixture was used, which was supplied via an annular burner located around the nozzle. The pressure drop was kept constant at 1.1 bar.

The flame synthesis conditions are summarized in Table 2.

TABLE 2
Test parameters for supports from flame-spray pyrolysis

| | | Flow rate of | | |
|---|---|---|---|---|
| | c_{Zr} | precursor | | Dispersion gas |
| | [mol/kg | compound | Total gas flow | flow |
| Solvent | solution] | [ml/h] | [l/h] | [l/h] |
| Xylene | 1 | 310 | 3500 | 1200 |

A baghouse filter was used for separating the particles. These filters could be cleaned by applying 5 bar pressure surges of nitrogen to the filter bags.

### Impregnation of the Flame-Synthesized Support

Impregnation was carried out as in example 4 in EP 1 074 301. A solution of SnCl₂ and H₂PtCl₆ in ethanol was poured over the flame-synthesized SiO₂/ZrO₂ support of sieve fraction 1-2 mm. The excess solution was removed in a rotary evaporator, and the solid material was dried and calcined. For this, an aqueous solution of CsNO₃ and La(NO₃)₃ was added and the supernatant was removed. After drying and calcination, the catalyst was obtained with a BET surface area of 23 m².

### Reference Catalyst

The reference catalyst according to EP 1 074 301 consists of 95 wt. % ZrO₂, 5 wt. % SiO₂ (support), 0.5 wt. % Pt, 1 wt. % Sn, 3% La, 0.5 wt. % Cs and 0.2 wt. % K (active and promoter metals relative to the mass of the support), produced according to example 4 by the wet-chemical route. The support was prepared by spray drying of the oxide mixture obtained by precipitation according to the sol/gel process.

### Catalytic Measurements

Propane dehydrogenation was carried out at approx. 600° C. 21 Nl/h total gas (20 Nl/h propane, 1 Nl/h nitrogen as internal standard), 5 g/h water. Regeneration is carried out at 400° C.: 2 hours 21 Nl/h N₂+4 Nl/h air; 2 hours 25 Nl/h air; 1 hour 25 Nl/h hydrogen.

The conversion, the long-term stability and the selectivity of propene formation were investigated in the catalytic tests. The catalyst obtained from flame synthesis with subsequent impregnation showed, in optimum operating conditions, 48% conversion and 95% selectivity in the autothermal dehydrogenation of propane to propene.

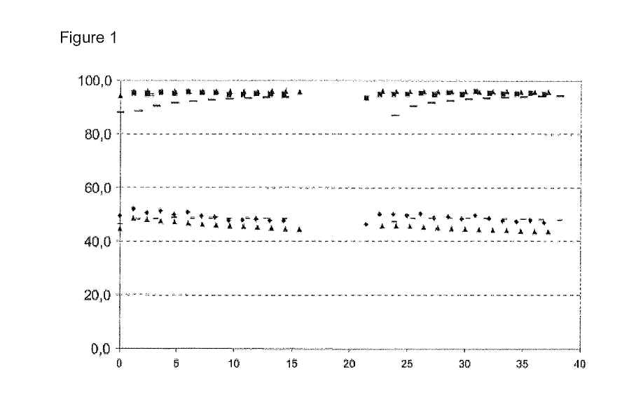

FIG. 1 shows, for comparison, the activities and selectivities of the reference catalyst (−) with support prepared by precipitation and spray drying and of the catalyst according to the invention, whose support is derived from flame synthesis (▪), with the additional elements applied in each case by impregnation. The results for an exclusively flame synthesized catalyst of the same composition (▴) are also shown. The time in hours is plotted on the abscissa, and the conversions (40 to 50%) and selectivities (>80%) for the autothermal dehydrogenation of propane to propene are plotted on the ordinate.

It can be seen that the three catalysts have comparable performance. The reference catalyst has lower initial selectivities. However, it equalizes over the test cycles of a few weeks. Thus, the flame-synthesized catalyst and the flame-synthesized support after wet-chemical application of the additional elements (according to the invention) behave like an aged catalyst, whose support was produced by spray drying

1-14. (canceled)

15. A method of production of catalyst support particles, containing zirconium dioxide and optionally silicon oxide, comprising the steps
(i) preparing a solution containing at least one precursor compound of zirconium dioxide and optionally of silicon dioxide,
(ii) converting the solution(s) to an aerosol,
(iii) bringing the aerosols into a directly or indirectly heated pyrolysis zone,
(iv) carrying out the pyrolysis,
(v) separating the catalyst particles formed from the pyrolysis gas.

16. The method as claimed in claim 15, wherein the pyrolysis zone is heated by a flame.

17. The method as claimed in claim 15, wherein the zirconium dioxide precursor compound comprises zirconium(IV) ethylhexanoate.

18. The method as claimed in claim 15, wherein the silicon dioxide precursor compound comprises hexamethyldisiloxane.

19. The method as claimed in claim 15, wherein the zirconium dioxide precursor compound comprise zirconium(IV) propoxylate.

20. The method as claimed in claim 15, wherein one or more of the precursor compounds are dissolved in a mixture of acetic acid, ethanol and water.

21. The method as claimed in claim 15, wherein one or more of the precursor compounds are dissolved in xylene.

22. The method as claimed in claim 15, wherein pyrolysis is carried out at a temperature of 900 to 1500° C.

23. Catalyst support particles obtainable by the method as claimed in claim 15.

24. A method of production of catalyst particles, comprising platinum and tin and at least one other element, selected from lanthanum and cesium on a zirconium dioxide-containing support, comprising the following steps:
(i) preparing a solution containing at least one precursor compound of zirconium dioxide and optionally of silicon dioxide,
(ii) converting the solution(s) to an aerosol,
(iii) bringing the aerosols into a directly or indirectly heated pyrolysis zone,
(iv) carrying out the pyrolysis,
(v) separating the catalyst particles formed from the pyrolysis gas
(vi) impregnating the catalyst support particles formed with one or more solutions containing compounds of platinum, tin and at least one other element, selected from lanthanum and cesium, and
(vii) drying and calcining of the impregnated catalyst support particles.

25. Catalyst particles obtainable by the method as claimed in claim 24.

26. The catalyst particles as claimed in claim 25, wherein they contain 0.05 to 1 wt. % Pt and 0.05 to 2 wt. % Sn.

27. The catalyst particles as claimed in claim 25 with a specific surface of 20 to 70 m²/g.

28. The catalyst particles as claimed in claim 25, comprising 30 to 99.5 wt. % ZrO₂, 0.5 to 25 wt. % SiO₂ as support and 0.1 to 1 wt. % Pt, 0.1 to 10 wt. % Sn, La and/or Cs, relative to the mass of the support, wherein at least Sn and at least La or Cs are contained.
